(19) United States
(12) Patent Application Publication
(10) Pub. No.: US 2020/0026822 A1
(43) Pub. Date: Jan. 23, 2020

(54) SYSTEM AND METHOD FOR POLYGENIC PHENOTYPIC TRAIT PREDISPOSITION ASSESSMENT USING A COMBINATION OF DYNAMIC NETWORK ANALYSIS AND MACHINE LEARNING

(71) Applicant: LifeNome Inc., New York, NY (US)

(72) Inventors: Ali Mostashari, New York, NY (US); Raya Khanin, New York, NY (US); Mario Storga, Zagreb (HR)

(21) Appl. No.: 16/041,810

(22) Filed: Jul. 22, 2018

(51) Int. Cl. G06F 19/18; G06F 19/24

(52) U.S. Cl. CPC G06F 19/18; G06F 19/28; G06F 19/24

(57) ABSTRACT

A method and system comprising receiving genetic and non-genetic data of an individual, calculating a trait predisposition score for the individual, organizing a knowledge base repository using dynamic network analysis of a plurality of genetic variants and of a plurality of phenotypic traits into a heterogeneous knowledge network model, assessing regulatory, catalytic or inhibitory utility of genetic factors by determining existence of said genetic factors within biological pathways, calibrating the phenotypic trait predisposition score for the individual using a machine learning analysis that relates the plurality of genetic variations to the plurality of phenotypic traits, calibrating the heterogeneous knowledge network model using the genetic data and the non-genetic data.

### 1. FIELD OF INVENTION

The present invention relates generally to the field of analyzing and utilizing genetic and non-genetic, i.e., behavioral, physiological, environmental, demographic, and the like, information to predict phenotypic traits outcomes. More specifically, the present invention relates to methods and systems which employ integrated and validated genetic and non-genetic (i.e., behavioral, physiological, environmental, and demographic) information from a reference population to provide actionable recommendations related to the health and well-being of a particular individual.

### II. PRIOR ART

Genetic variations in human DNA such as single nucleotide polymorphisms (SNPs), indels, structural variations, copy number and fusion events, can result in differences in the expressed phenotypic traits of individuals, including but not limited to physical appearance, nutrient absorption, metabolism, skin and hair characteristics, sleep, personality, predisposition to disorders, conditions and diseases. Currently, and as a result of numerous ongoing research studies, there is rapidly growing knowledge on genetic variations-phenotypic traits associations. This knowledge can be utilized to assess an individual's predisposition to expressing phenotypic traits based on the multitude of their genetic variations, behavioral factors, and other social and environmental factors, including but not limited to age, gender, ethnicity, or lifestyle. One of the challenges inadequately addressed by current approaches is the shortcoming in assessing how the result of the associations of several genetic variations with a single phenotypic trait can be combined, so that the relative strength of the predisposition potential can be understood.

Prior art approaches to dealing with complex traits fall within three categories. First category is a simple presence-based: If genetic variations are present in any number, then there is predisposition (without measurement of strength). In this case a person with three genetic variations correlated with one phenotype trait is as likely to be predisposed to that trait as a person with one genetic variation. Second category is a simple additive based: the association strength of correlated multiple genetic variations to a single phenotypic trait are simply additive in nature, meaning that the existence of three genetic variations in a person's DNA makes them three times as likely to be predisposed to having a phenotypic trait compared to a person with one genetic variation. Third category is a purely statistical approach to combine the significance of associations from different studies into a combined association correlation using discrete meta-analysis.

The first two approaches do not take into consideration a relative strength of correlations of each of the individual genetic variations with the target trait, as well as the role of the genetic variation within the biochemical pathway of protein expression or regulation.

The third approach assumes discrete and independent correlations, which is an arbitrary assumption that is not congruent with the understanding of the potentially interrelated nature of common and rare genetic variations.

Furthermore, all three approaches fail to establish a threshold of predisposition assessment, which requires cross-comparability of the individual's strength of predisposition potential with that of the larger population to address when such predisposition would be outside of normal range and fails to calibrate recommendations based on the assessed strength of the predisposition.

It is therefore necessary to construct additional systems and methods that optimally combine multiple genetic and non-genetic, i.e., behavioral, physiological, environmental, demographic, and the like, information into an integrated predisposition assessment model, as opposed to simple association models.

### III. SUMMARY

This invention claims a method for Phenotypic Trait Predisposition Assessment Based on the Multiple Genetic Variations in DNA Using a Combination of Dynamic Network Analysis and Machine Learning. The present invention is directed to a new method and system for utilizing personal genetic and non-genetic information for computation of an individual's predisposition to phenotypic traits. Preferred embodiments of the present invention illustrate a system for analysis of genetic and non-genetic information and computing the predisposition for particular phenotypic traits. A preferred embodiment of the present invention comprises a reference genome population and a received personal genome. A preferred embodiment of the present invention also comprises receiving a personal genetic and non-genetic data, analyzing the received data, computing the phenotypic predispositions, and providing actionable health and well-being recommendations in accordance with the computed predisposition for the phenotypes.

The disclosed method and system accounts for a score for each phenotype trait in comparison to a reference population. The dynamic network analysis is used to extract a new knowledge about associations between the genetic variations and phenotypic traits used by the computational model, while machine learning is used to improve predictability and accuracy of the computational model by including the acquired phenotypic data and non-genetic information for predisposition score classification and calibration.

A preferred embodiment of the disclosed method and system utilizes most advanced knowledge on associations between genetic variations and phenotypic traits as reported in Genome Wide Association Studies (GWAS), Phenome-Wide Association Studies (PHEWAS), national and international health resources (e.g. UK Biobank), and other scientific resources that report on the effect of genetic variations on gene expression (Expression Quantitative Trait Loci, eQTL) in multiple tissues (GTeX).

The disclosed method and system provides a robust framework to compute individual's predisposition score for phenotypic traits based on multiple genetic variations, and predisposition assessment categorization relative to the general population or subpopulation.

### IV. BRIEF DESCRIPTION OF THE DRAWINGS

FIG. 1 is a block diagram illustrating the method for polygenic phenotypic trait predisposition assessment using a combination of dynamic network analysis and machine learning, according to an embodiment of the present invention;

FIG. 2 is a block diagram illustrating the algorithm employed by Knowledge-Base Module (KBM) for dynamic network creation and cluster analysis in continuous time, according to an embodiment of the present invention;

FIG. 3. is a block diagram illustrating the machine learning model used for the calibration of the impact of genetic variations, phenotypic, social and environmental information on trait predisposition score, according to an embodiment of the present invention; and

FIG. 4 is an illustration of an exemplary system that may be used to implement the functions and processes of certain embodiments of the present invention.

### V. DETAILED DESCRIPTION

The preferred embodiment of the present invention is implemented as a computational methodology and a software application system for (1) organizing and dynamically structuring knowledge about associations between genetic variations and phenotypic traits, (2) calculating phenotypic trait predisposition score based on multiple genetic variations, (3) assessing phenotypic trait predisposition categories in relation to general population, or to a specific subpopulation, (4) reporting on individual's trait predisposition and action recommendations on how to address it, and (5) calibrating of the scoring and classification algorithm based on the population-based genetic and non-genetic information.

Genetic variations comprise single nucleotide polymorphisms (SNPs), indels, structural variations, and fusion, within human DNA derived from an analysis of genetic materials of an individual, such as saliva samples, cheek swabs, blood, hair, and the like.

The disclosed system and method calculate a phenotypic trait predisposition score, assess the predisposition category with regards to a larger population, and establish thresholds for phenotypic trait predisposition significance based on that comparison.

As an output, the disclosed method and system generate a predisposition assessment score for a phenotypic trait or traits of interest as well as the relative predisposition with respect to the general population or subpopulation.

The disclosed method and system also uses the machine learning models to calibrate predisposition assessment score and classification algorithms and to improve predictability and accuracy measures by updating the core knowledge model, as well as incorporating genetic and non-genetic information from the individuals.

A detailed description of one or more embodiments of the disclosed invention is provided herein along with accompanying figures that illustrate the principles of the invention.

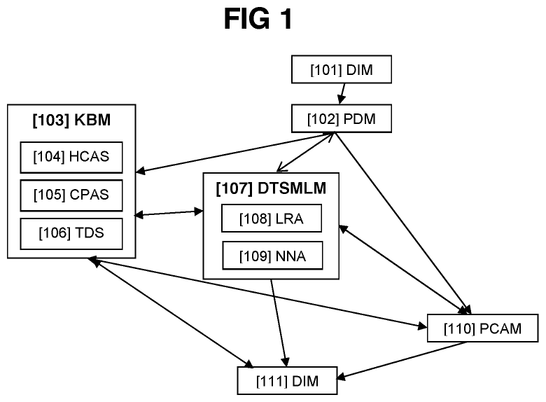

FIG. 1 is block diagram illustrating a preferred embodiment of a system 100 for Polygenic Phenotypic Trait Predisposition Assessment Using a Combination of Dynamic Network Analysis and Machine Learning.

System 100 depicted in FIG. 1 comprises Data Input Module (DIM) 101, Population Database Module (PDM) 102, Knowledge-Base Module (KBM) 103, Discovery and Trait Score Machine Learning Module (DTSMLM) 107, Percentile Calculation and Assessment Module (PCAM) 110, and Reporting and Recommendation Module (RRM) 111. DIM 101 is communicatively connected with PDM 102. In turn, PDM 102 is communicatively connected with KBM 103, DTSMLM 107, and PCAM 110. DTSMLM 107 is communicatively coupled with KBM 103, PCAM 110, and RRM 111. KBM 103 is also communicatively connected with PCAM 110 and RRM 111. PCAM 110 is communicatively connected to RRM 111.

DIM 101 receives genetic and non-genetic data of an individual. The genetic data is derived from a number of human samples, such as saliva, blood, skin, hair, and the like, and comprises DNA genotype arrays, or DNA sequencing. The non-genetic information comprises data about individual's gender, age, ethnicity, education, profession, height, weight, activity level, diet, habits, lifestyle, working environment, medical history, and the like. DIM 101 receives data from various sources, including uploading a file with genotype data inputted by an individual, by external genotyping or sequencing service/company using generic or proprietary Application Programming Interface (API), or by a third party (e.g. physician, nutritionist). Upon receipt of data, DIM 101 propagates the received genetic and non-genetic data to PDM 102 for storage.

PDM 102 is a repository of genetic and non-genetic information for a plurality of individuals. PDM 102 constitutes the basis for phenotypic trait predisposition assessment score computation. The data stored on PDM 102 is continuously updated with new entries received from DIM 101. PDM 102 can also be updated by bulk downloads of multiple genetic data, and non-genetic information from third parties and open-source contributors.

PDM 102 also stores phenotypic trait predisposition scores for the reference population as computed and assessed in DTSMLM 107. The computed and assessed predisposition scores within PDM 102 serve as inputs for PCAM 110.

Module KBM 103 is a dynamically updated and organized context-rich knowledge network describing the associations between genetic variations and phenotypic traits, information on biological pathways, and statistical data on phenotypic characteristics added from external sources. KBM 103 functions as a reference module for DTSMLM 107 and for PCAM 110.

The KBM 103 comprises three submodules: High-dimensional Cluster Analysis Sub-module (HCAS) 104, Critical Pathways Analysis Sub-module (CPAS) 105, and Threshold Determination Sub-module (TDS) 106.

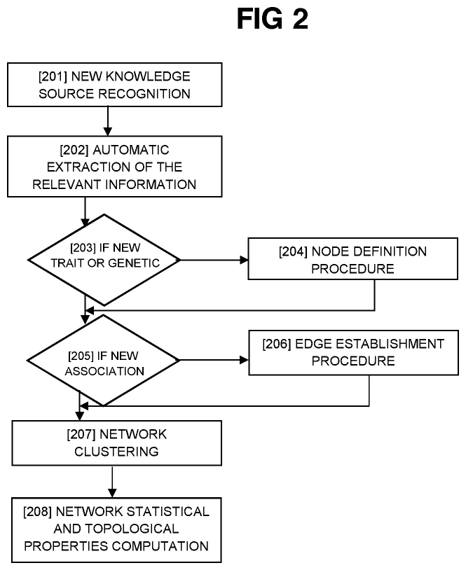

FIG. 2 illustrates the algorithm 200 employed by KBM 103 for dynamic knowledge network creation and cluster analysis in continuous time. KBM 103 heterogeneous network model is updated by utilizing context-rich search and information extraction engine that analyzes multiple scientific sources, comprising publications, research studies, tables, supplementary materials, scientific databases, national and international health databases, as well as biological pathway databases 201.

In algorithm 200 of FIG. 2, upon recognizing an existence of a new knowledge source at step 201, an extraction of relevant data is initiated in step 202. Natural language processing (NLP) algorithms on identified knowledge sources are applied for the extraction of the new relevant knowledge bits describing the newly discovered associations between genotypic variations and phenotypic traits. The process of extraction of relevant data in step 202 comprises identification of the relevant information, processing it, and transforming it in the format that is needed for the further utilization within the algorithm 200.

Phenotypic traits ontology is used as the means to represent, normalize and utilize the common concepts and knowledge extracted from different information sources. The step 202 of ontology-based and pattern-based information extraction and selection techniques are used to provide the new insights that are dynamically applied in the knowledge network model. The extracted knowledge enriches the knowledge network model and validates association edges between genetic variations nodes and phenotypic traits nodes.

Upon conclusion of the extraction of relevant new knowledge in step 202, in step 203 a determination is made as to whether new genetic variations or phenotypic traits are detected in the step 202. The determination in step 203 is conducted by applying the advanced semantic search algorithms enabling semantic matching between existing and newly identified knowledge bits.

The nodes of the heterogeneous network model represent either genetic variations or phenotypic traits and are unique within the network model (steps 203, 204). The network is bipartite, so only associations between the genetic variations and phenotypic traits are allowed in the knowledge network.

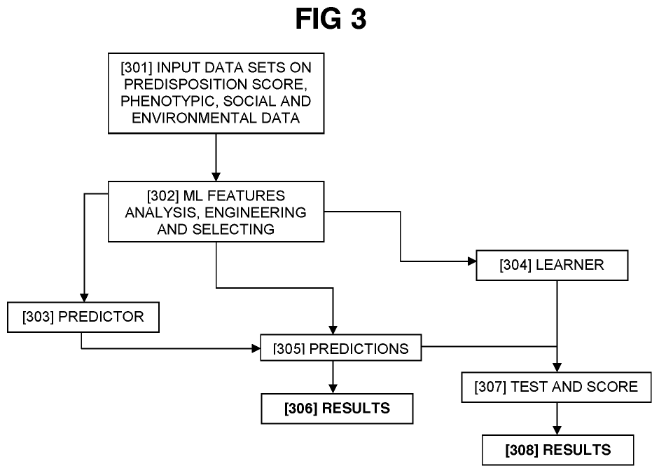

The nodes are connected by association edge if relation between genetic variation and phenotypic trait is reported within the same knowledge source that was used for building the knowledge network (steps 204, 205), or if they are discovered as significant by statistical analysis of the data acquired from resources including but not limited to scientific databases, national and international health databases, as well as biological pathway databases (step [304 of FIG. 3). Such knowledge network constitutes the core of the KBM 103.

If new genetic variations or phenotypic traits detected within the knowledge source in step 203, a node definition procedure is commenced in step 204. The node definition procedure comprises by adding the new unique node to the knowledge network with all relevant properties needed for the further utilization.

If, in step 203, no new genetic variations or phenotypic traits are detected, the node definition procedure of step 204 is not commenced. Instead, a determination as to whether a new association between genetic variation and phenotypic trait exists within the knowledge source is performed in step 205. The determination whether a new association between genetic variation and phenotypic trait exists within the same knowledge source comprises of semantic analysis of the knowledge source in order to extract the knowledge about the reported association between genetic variation and phenotypic traits and the comparison of the results with the associations already existing in the knowledge base.

If, in step 205, the determination is made that a new association between genetic variation and phenotypic trait exists within the new knowledge source, an edge establishment procedure is commenced in step 206. In an embodiment of the present invention, the edge establishment procedure comprises of adding the new unique edge to the knowledge network with all relevant properties needed for the further utilization.

Upon determining, in step 205, that no new association between genetic variation and phenotypic trait exists, or, upon completion of the edge establishment procedure in step 206, algorithm 200 initiates a process of network clustering in step 207 that is responsibility of the HCAS 104. The process of network clustering of step 207 comprises of application of the network clustering algorithms with the goal to identify topological structures within the knowledge network.

The purpose of the clustering process of step 207 is to assign genetic variations and phenotypic traits to either separate or overlapping groups (communities) according to density of the ties between them. Since the vector with genetic variants for each trait may consist of many hundreds of genetic variants, the high dimensional clustering approach is applied to avoid ineffectiveness of the traditional approaches. Clustering of the KBM network model takes the edges between nodes into consideration to map clusters of genetic variations to clusters of phenotypic traits in step 207. Clustering automatically takes into account data on linkage disequilibrium between genetic variations, and phenotypic trait ontology structure. Clustering of the KBM network enables (1) quantification of the impact of multiple genetic variations on multiple phenotypic traits, (2) integration of multiple heterogeneous sources of information, (3) exploratory analysis and prediction of the unknown associations between genetic variations and phenotypic traits.

Upon conclusion of the process of network clustering of step 207, algorithm concludes at step 208 when statistical and topological properties of the knowledge network are computed. Specifically, results of the statistical and topological properties computations of the knowledge network and network elements are used as the key input for the phenotypic traits predisposition score computations. For example, the statistical network properties of the specific association between genetic variation phenotypic traits such as edge centrality, is used for determination of the initial weight that serves as an input for computation of predisposition score in PCAM 110. Another example is the usage of the topological properties of the knowledge network within particular cluster for prediction of the missing associations between the genotypic variations and phenotypic traits.

In an embodiment, the process of computation of network statistical and topological properties comprises of implementation of the scalable algorithms for the dynamic network analysis and visualization to augment analysis of the complex knowledge structures evolution.

A person skilled in the art understands that the manner with which steps 201-208 are commenced or performed as described herein is exemplary and is intended merely to illustrate one or more embodiments and does not pose a limitation on the scope of the disclosed embodiments unless otherwise stated.

Returning to FIG. 1, as noted earlier, module KBM 103 comprises the submodule HCAS 104. The main function of HCAS 104 is to organize and structure the information about associations between the genetic variations and phenotypic traits incorporated within the heterogeneous knowledge network model during the advanced clustering process in step 207 of FIG. 2.

In one of the examples, based on the network analysis of the GWAS studies, it is possible to compute the community of the phenotypic traits that is created by being influenced by the same phenotypic variants. One of the such discovered clusters consist of the following traits: Diet Low Fat Cholesterol, Age Related Macular Degeneration, Well Being Coenzyme Q10, Skin Antioxidant, Skin Pollution Defense, Sensitivity to Sun and Estrogen Levels connected to the 100 common genetic variants.

One other submodule of KBM 103 is CPAS 105. One of the main functions of CPAS 105 is to identify biological pathways of interest from multiple sources and databases. Biological pathways of interest include, but are not limited, to biological pathways related to essential or trace micronutrients, natural or synthetic ingredients in foods, drinks, skin or hair care products, allergens, and exogenous substances from the environment (further referred as substance, S). For each substance of interest, S, biological pathways are sought that play role in the following (1) conversion of S to a more bioactive form, or intermediate form that is required for further processing/metabolism, (2) transport of S to tissues, and organs, (3) recycling of S, (4) elimination of S, (5) enzymatic reactions where S, is an enzyme, or substrate, (6) upstream regulation of key genes in one of these pathways. These biological pathways are given as an illustration, and other pathways that may affect general physical, psychological well-being, appearance, personality, may be included as well. The functional impact of genetic variations in coding and non-coding genes within these pathways are identified using state of the art bioinformatics methods, including but not limited to methods like SIFT http://sift.bii.a-star.edu.sg/ and Polyphen http://genetics.bwh.harvard.edu/pph2/.

The output from the CPAS 105 sub-module is taken into account in the clustering process performed by HCAS 104 in step 207 of FIG. 2.

In addition, the CPAS 105 sub-module searches through existing external databases and data repositories that report on the effect of genetic variations on phenotypic traits such as gene expression, protein levels, binding sites for transcription factors, protein-protein interactions, RNA-RNA interactions, and rates of metabolic reactions. For example, gene AQP3 codes for the most abundant skin aquaporin that transports water, glycerol and urea across the plasma membrane. This gene regulates skin hydration, skin barrier recovery and wound healing. Lower expression of AQP3 gene results in reduced activity in epidermis leading to impairments in skin intrinsic hydration capacity, and skin dryness. GTeX database reports over 60 genetic variants that are significantly associated with the expression of the AQP3 gene in both sun-exposed and not-exposed skin. Hence, these genetic variants are likely to be related to several phenotypic traits that depend the AQP3 expression, such as skin dryness, skin hydration, skin barrier recovery, skin wound healing. These genetic variants are to be included in the knowledge network (KBM 103) as nodes, associations between variants and phenotypes as edges, and as such being utilized as an input to HCAS 104.

TDS 106, a third submodule of KBM 103, is configured to automatically determine the population-related thresholds for phenotypic traits by combining statistical data on population-based predispositions for various phenotypic traits, and genetic data, received from PDM 102. Specifically, TDS 106 dynamically updates statistical data on population-based predispositions for various phenotypic traits, comprising low levels of essential and trace vitamins and minerals, risks for obesity, allergies, incidences of disorders, conditions, diseases. The threshold data determined by TDS 106 is used as an input for PCAM 110 to identify individuals who is a part of the predisposition assessment category for a specific trait.

For example, according to the National Health and Nutrition Examination Survey, up to 45% of general US population have inadequate levels of vitamin D (less than 30 nanograms per milliliter). This information is stored within the TDS 106 submodule, and it is used for individual predisposition assessment. If the individual's predisposition assessment to vitamin D deficiency based on multiple genetic variations is within the lowest 45% of general US population, this individual is reported as having higher predisposition risk of vitamin D deficiency.

DTSMLM 107 uses the individual's genetic data received, via PDM 102, from DIM 101 to extract the genetic variations related to multiple phenotypic traits, as defined by the KBM 103 knowledge network model, and to compute the individual's phenotypic traits predisposition score using machine learning sub-modules, i.e., logistic regression analysis (LRA) 108 or Neural Network Analysis (NNA) 109 used for multi-trait deep learning. The computed predisposition score is used as an input to PCAM 110.

It is to be understood that, in addition to the LRA 108 and NNA 109, other machine and deep learning approaches are utilized for each particular phenotypic trait and group of the traits in order to perform multi-trait analysis and exportation of the assessment predictions that are aimed to development of the more generic computational models that are enabled by the embodiment of the proposed method and system. Also, the aggregated influence of the genetic variants projected to the gene regions in combination with the consideration of the molecular level phenotypes is used for the improvement of the machine learning models.

LRA 108 determines the magnitude of the predisposition as compared to the rest of the population. LRA 108 also serves as a validation mechanism for the DTSMLM 107 and takes the individual's phenotypic trait predisposition score based on genetic variations and non-genetic information and calculates the phenotypic trait percentile by comparing the individual's predisposition score with population scores received from PDM 102. Depending on the phenotypic trait percentile value within the trait specific threshold intervals, as defined by TDS 106, the corresponding assessment category is reported.

FIG. 3 is a block diagram illustrating the machine learning model algorithm 300 used for the calibration of the impact of genetic variations, phenotypic, social and environmental information on trait predisposition score.

Algorithm 300 of FIG. 3 is executed by LRA 108 module of DTSMLM 107.

In a preferred embodiment of the present invention, in step 301 of algorithm 300, LRA 108 uses the individual's predisposition score with the non-genetic information provided by the individual, and the data gathered from the national and international health resources, for example UK Biobank, to explore and calibrate the impact of genetic variations on trait predisposition score, assessment classification and improve phenotypic predictions for new cases with similar genetic variations.

In addition to receiving the genetic and non-genetic information from PDM 102 in step 301, additional features for advanced machine learning are engineered by observing their polynomial combinations and interactions in step 302 prior to application of the LRA 108.

The dimensionality reduction is used on such engineered set of features to improve accuracy scores and to boost performance of the machine learning used for assessment classification by LRA 108, and to further refine and analyze the high-dimensional genetic variations and phenotypic traits domain knowledge network constructed in KBM 103.

In contrast to identifying genetic variants explaining phenotypic variations at the population level as done by standard statistical association testing approach, supervised machine learning model used within DTSMLM 107 and incorporating non-genetic information in addition to the genetic variants, maximize the predictive power at the level of individuals and provide the base for individualized predisposition assessment completed in steps 303, 304. In the step 303 models' predictions on the provided genetic and non-genetic information are executed and analyzed, while in the step 304 learning algorithms are tested and validated.

Incorporating the non-genetic information from the individuals enables the steps 305, 306 of building different prediction models for different populations, where topology and importance of various genetic variations associated to the particular trait are different.

Machine learning model applied here can also deal with genetic variants interactions which play important role in steps 307, 308 of visualization, understanding and evaluation of the complex polygenic phenotypic traits.

In some embodiments, the assessment category for a phenotypic trait is defined at number of levels, such as for example low predisposition, slightly elevated, and elevated. In another embodiment, three levels for the assessment category are defined as typical, slightly advantageous, advantageous. Similarly, assessment categories for a phenotypic trait can have two levels (no predisposition, predisposition) or four or more levels, defined, for example, as low predisposition, slightly elevated, elevated, highly elevated.

In some other embodiments, traits with three levels for assessment categories (low risk, slightly elevated, elevated) can have two thresholds that are defined in TDS 106. If an individual's phenotypic trait percentile is above the highest threshold, then the assessment category for this trait is reported as elevated. If individual's phenotypic trait percentile is within the interval between two thresholds, then the assessment category for this trait is reported as slightly elevated. If individual's phenotypic trait percentile is below the lowest threshold, then the assessment category for this trait is reported as typical or low predisposition. Similar logic is applied to traits with four or more levels of assessment categories.

Returning to FIG. 1, RRM 111 provides structured phenotype assessment and recommendations outputs to be used in further applications. The outputs include but are not limited to the trait predisposition score, the percentile score for the relevant population, assessment category, list of genetic variations that contribute to the phenotypic trait predisposition score, and recommendations on how to address potential predispositions if applicable.

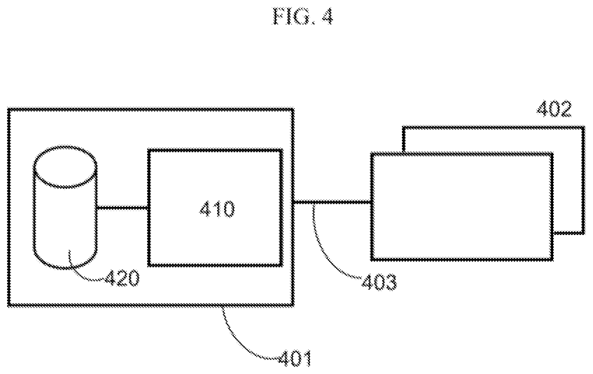

FIG. 4 presents a computing system according to an embodiment of the present invention. The present invention includes an apparatus which includes at least one processor and memory storing computer program instructions, which when executed on the processor, causes the processor to perform the steps of the described method. It is to be understood that the processor may be installed in or be in communication with at least one server device 401.

The at least one server device 401 is communicatively coupled with a plurality of user input devices 402 over a communications network 403. The user input devices 402 may be configured to communicate with the at least one server device 401 to receive the data sent by the server device 401 in accordance with steps described in FIGS. 1-3 in the present application. The plurality of user devices 402 may be any number of known electronic devices, including but not limited to hand-held electronic devices, portable and stationary computing devices, and electronic user interfaces having a wired and/or wireless transceiver. It is to be understood that the memory is capable of storing data in all known formats.

The foregoing description of the preferred embodiment of the invention has been presented for purposes of illustration and description. It is not intended to be exhaustive or to limit the invention to the precise form disclosed. Many alternatives, modifications, and variations will be apparent to those skilled in the art in light of the above teaching.

FIGS. 1 through 4 are conceptual illustrations allowing for an explanation of the present invention. Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein.

Moreover, applicants do not intend for any term in the specification or claims to be ascribed an uncommon or special meaning unless explicitly set forth as such. Further, the present invention encompasses present and future known equivalents to the known components referred to herein by way of illustration.

It should be understood that various aspects of the embodiments of the present invention could be implemented in hardware, firmware, software, or combinations thereof. In such embodiments, the various components and/or steps would be implemented in hardware, firmware, and/or software to perform the functions of the present invention. That is, the same piece of hardware, firmware, or module of software could perform one or more of the illustrated blocks (e.g., components or steps). In software implementations, computer software (e.g., programs or other instructions) and/or data is stored on a machine-readable medium as part of a computer program product and is loaded into a computer system or other device or machine via a removable storage drive, hard drive, or communications interface. Computer programs (also called computer control logic or computer readable program code) are stored in a main and/or secondary memory, and executed by one or more processors (controllers, or the like) to cause the one or more processors to perform the functions of the invention as described herein. In this document, the terms “machine readable medium,” “computer readable medium,” “computer program medium,” and “computer usable medium” are used to generally refer to media such as a random access memory (RAM); a read only memory (ROM); a removable storage unit (e.g., a magnetic or optical disc, flash memory device, or the like), a hard disk, network (cloud) drive, or the like.

The foregoing description of the specific embodiments will so fully reveal the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

While various embodiments of the present invention have been described above, it should be understood that they have been presented by way of example, and not limitation. It would be apparent to one skilled in the relevant art(s) that various changes in form and detail could be made therein without departing from the spirit and scope of the invention. Thus, the present invention should not be limited by any of the above-described exemplary embodiments but should be defined only in accordance with the following claims and their equivalents.

What is claimed is:

1. A method for Phenotypic Trait Predisposition Assessment Based on the Multiple Genetic Variations in DNA Using a Combination of Dynamic Network Analysis and Machine Learning, comprising:
receiving, by a server, genetic and non-genetic data of an individual;
calculating, by the server, a trait predisposition score for the individual, wherein the phenotypic trait predisposition score is a reference score;
organizing, by the server, a knowledge base repository using dynamic network analysis of a plurality of genetic variants and of a plurality of phenotypic traits into a heterogeneous knowledge network model;
assessing, by the server, regulatory, catalytic or inhibitory utility of genetic factors by determining existence of said genetic factors within biological pathways, the biological pathways comprising at least one of metabolic pathways, regulatory networks and signal transduction pathways;
calibrating, by the server, the phenotypic trait predisposition score for the individual using a machine learning analysis that relates the plurality of genetic variations to the plurality of phenotypic traits; and
calibrating, by the server, the heterogeneous knowledge network model using the genetic data and the non-genetic data.

2. The method of claim 1, wherein organizing a knowledge base repository comprises:
recognizing an existence of a new knowledge source;
extracting data from the new knowledge source, wherein the extracting comprises identification of relevant data, processing the relevant data, and formatting the relevant data;
determining whether at least one of the new genetic variations and phenotypic traits are detected in the data extracted from the new knowledge source;
upon determining that the at least one of the new genetic variations and phenotypic traits are detected in the data extracted from the new knowledge source, conducting a node definition;
determining whether an association between the new genetic variations and phenotypic trait exists within the new knowledge source;
upon determining that the association between the new genetic variations and phenotypic trait exists within the new knowledge source, commencing an edge establishment;
upon completion of the edge establishment, identifying at least one topological structure within the knowledge network model using a network clustering algorithm; and
computing statistical and topological properties of the knowledge network model.

3. The method of claim 2, wherein the determining whether at least one of the new genetic variations and phenotypic traits are detected in the data extracted from the new knowledge source comprises applying at least one semantic search algorithm enabling semantic matching between existing and newly identified knowledge bits.

4. The method of claim 2, wherein the node definition comprising adding a new node to the heterogeneous knowledge network model.

5. The method of claim 2, wherein the determining whether an association between the new genetic variations and phenotypic trait exists within the new knowledge source comprises semantic analysis of the new knowledge source to extract knowledge about association between the new genetic variations and phenotypic traits and comparison of results with associations existing in the knowledge base.

6. The method of claim 2, wherein the edge establishment comprises addition of a new unique edge to the knowledge network model.

7. The method of claim 1, further comprising:
extracting the genetic variations related to the plurality of phenotypic traits and defined by the knowledge network model; and
computing a phenotypic traits predisposition score using machine learning sub-modules.

8. The method of claim 1, further comprising:
providing a base for a predisposition assessment using a standard statistical association testing, a supervised machine learning model, and incorporating non-genetic information in addition to the genetic variants;
incorporating the non-genetic data from the individual enabling building prediction models for at least one population; and
applying a machine learning model for genetic variation interactions enabling evaluation of polygenic phenotypic traits.

9. An apparatus for Phenotypic Trait Predisposition Assessment Based on the Multiple Genetic Variations in DNA Using a Combination of Dynamic Network Analysis and Machine Learning, the apparatus comprising:
a processor; and
a memory having executable instructions stored thereon that when executed by the processor cause the processor to:
receive a genetic data and a non-genetic data of an individual;
calculate a phenotypic trait predisposition score for the individual, wherein the first phenotypic trait predisposition score is a reference score;
organize a knowledge base repository using dynamic network analysis of a plurality of genetic variants and of a plurality of phenotypic traits into a heterogeneous knowledge network model;
assess regulatory, catalytic or inhibitory utility of genetic factors by determining existence of said genetic factors within biological pathways, the biological pathways comprising at least one of metabolic pathways, regulatory networks and signal transduction pathways;
calibrate the phenotypic trait predisposition score for the individual using a machine learning analysis that relates the plurality of genetic variations to the plurality of phenotypic traits; and
calibrate the heterogeneous knowledge network model using the genetic data, the non-genetic data, the first phenotypic trait predisposition score and the second phenotypic trait predisposition score.
represent, through an advanced programming interface (API), the results of the predisposition assessment to client applications.

10. The apparatus of claim 9, the executable instructions when executed by the processor further cause the processor to:
extract the genetic variations related to the plurality of phenotypic traits and defined by the knowledge network model;
compute a phenotypic traits predisposition score using machine learning sub-modules;
provide a base for a predisposition assessment using a standard statistical association testing, a supervised machine learning model, and incorporating non-genetic information in addition to the genetic variants;
incorporate the non-genetic data from the individual enabling building prediction models for at least one population; and
apply a machine learning model for genetic variation interactions enabling evaluation of polygenic phenotypic traits.

11. A non-transitory computer readable media comprising program code that when executed by a programmable processor causes execution of a method for Phenotypic Trait Predisposition Assessment Based on the Multiple Genetic Variations in DNA Using a Combination of Dynamic Network Analysis and Machine Learning, the computer readable media comprising:
receiving a genetic data and a non-genetic data of an individual;
calculating a phenotypic trait predisposition score for the individual, wherein the first phenotypic trait predisposition score is a reference score;
organizing a knowledge base repository using dynamic network analysis of a plurality of genetic variants and of a plurality of phenotypic traits into a heterogeneous knowledge network model;
assessing regulatory, catalytic or inhibitory role utility of genetic factors by determining existence of said genetic factors within biological pathways, the biological pathways comprising at least one of metabolic pathways, regulatory networks and signal transduction pathways;
calibrating the phenotypic trait predisposition score for the individual using a machine learning analysis that relates the plurality of genetic variations to the plurality of phenotypic traits; and
calibrating the heterogeneous knowledge network model using the genetic data and the non-genetic data.

12. The non-transitory computer readable media of claim 11, wherein organizing a knowledge base repository comprises:
recognizing an existence of a new knowledge source;
extracting data from the new knowledge source, wherein the extracting comprises identification of relevant data, processing the relevant data, and formatting the relevant data;
determining whether at least one of the new genetic variations and phenotypic traits are detected in the data extracted from the new knowledge source;
upon determining that the at least one of the new genetic variations and phenotypic traits are detected in the data extracted from the new knowledge source, conducting a node definition;
determining whether an association between the new genetic variations and phenotypic trait exists within the new knowledge source;
upon determining that the association between the new genetic variations and phenotypic trait exists within the new knowledge source, commencing an edge establishment;
upon completion of the edge establishment, identifying at least one topological structure within the knowledge network model using a network clustering algorithm; and
computing statistical and topological properties of the knowledge network model.

13. The non-transitory computer readable media of claim 12, wherein the determining whether at least one of the new genetic variations and phenotypic traits are detected in the data extracted from the new knowledge source comprises applying at least one semantic search algorithm enabling semantic matching between existing and newly identified knowledge bits.

14. The non-transitory computer readable media of claim 12, wherein the node definition comprising adding a new node to the heterogeneous knowledge network model.

15. The non-transitory computer readable media of claim 12, wherein the determining whether an association between the new genetic variations and phenotypic trait exists within the new knowledge source comprises semantic analysis of the new knowledge source to extract knowledge about association between the new genetic variations and phenotypic traits and comparison of results with associations existing in the knowledge base.

16. The non-transitory computer readable media of claim 12, wherein the edge establishment comprises addition of a new unique edge to the knowledge network model.

17. The non-transitory computer readable media of claim 11, further comprising:
extracting the genetic variations related to the plurality of phenotypic traits and defined by the knowledge network model; and
computing a phenotypic traits predisposition score using machine learning sub-modules.

18. The non-transitory computer readable media of claim 11, further comprising:
providing a base for a predisposition assessment using a standard statistical association testing, a supervised machine learning model, and incorporating non-genetic information in addition to the genetic variants;
incorporating the non-genetic data from the individual enabling building prediction models for at least one population; and
applying a machine learning model for genetic variation interactions enabling evaluation of polygenic phenotypic traits.

19. Method of claim 1, further comprising representing, through an advanced programming interface (API), the results of the predisposition assessment to client applications.
